(19) United States
(12) Patent Application Publication
(10) Pub. No.: US 2025/0348999 A1
(43) Pub. Date: Nov. 13, 2025

(54) RECORDING MEDIUM, INFORMATION PROCESSING METHOD, AND INFORMATION PROCESSING APPARATUS

(71) Applicant: Tokyo Electron Limited, Tokyo (JP)

(72) Inventors: Ruiki KOBAYASHI, Sapporo City (JP); Masaki KITSUNEZUKA, Sapporo City (JP)

(73) Assignee: Tokyo Electron Limited, Tokyo (JP)

(21) Appl. No.: 19/280,446

(22) Filed: Jul. 25, 2025

Related U.S. Application Data
(63) Continuation of application No. PCT/JP2024/002108, filed on Jan. 24, 2024.

(30) Foreign Application Priority Data
Jan. 26, 2023 (JP) 2023-010470

(51) Int. Cl. G06T 7/00; G06V 10/40; G06V 10/77; G06V 10/776; G06V 10/82

(52) U.S. Cl. CPC G06T 7/001; G06V 10/40; G06V 10/7715; G06V 10/776; G06T 2207/20081; G06T 2207/20084; G06T 2207/30121; G06T 2207/30148; G06V 10/82; G06V 2201/06

(57) ABSTRACT

A non-transitory computer readable recording medium storing a computer program causing a computer to execute a process of acquiring data related to substrate processing, extracting features of acquired data, using a first learning model which has been trained to output features of data in response to an input of the data, converting extracted features into features having a set target dimension, and computing a predicted value by inputting the features with converted dimension to a second learning model, which has been trained to output the predicted value related to the substrate processing in response to an input of the features having the target dimension.

### CROSS-REFERENCE TO RELATED APPLICATIONS

This application is a bypass continuation application of International Application No. PCT/JP2024/002108 having an international filing date of Jan. 24, 2024, and designating the United States, the international application being based upon and claiming the benefit of priority from Japanese Patent Application No. 2023-010470, filed on Jan. 26, 2023, the entire contents of each are incorporated herein by reference.

### TECHNICAL FIELD

The present invention relates to a recording medium, an information processing method, and an information processing apparatus.

### BACKGROUND

In the related art, in a field of substrate processing, utilization of virtual measurement technology has been advancing. In the virtual measurement technology, for example, measurement data obtained during the processing of an object, such as a substrate, is analyzed, and a predicted value for the resulting product is computed.
Patent Literature 1: Japanese Published Patent Publication No. 2019-537240

### SUMMARY

The present disclosure provides a recording medium, an information processing method, and an information processing apparatus that can perform analysis that takes spatial correlation into account, using a learning model.

According to an aspect of the present disclosure, there is provided a non-transitory computer readable recording medium storing a computer program causing a computer to execute a process of: acquiring data related to substrate processing; extracting features of acquired data, using a first learning model which has been trained to output features of data in response to an input of the data; converting extracted features into features having a set target dimension; and computing a predicted value by inputting the features with converted dimension to a second learning model, which has been trained to output the predicted value related to the substrate processing in response to an input of the features having the target dimension.

According to the present disclosure, it is possible to perform analysis that takes spatial correlation into account, using a learning model.

### BRIEF DESCRIPTION OF DRAWINGS

FIG. 1 is an explanatory diagram depicting a configuration of an information processing system according to an embodiment.

FIG. 2 is an explanatory diagram depicting a prediction method in Embodiment 1.

FIG. 3 is a block diagram depicting an internal configuration of an information processing apparatus.

FIG. 4 is a flowchart depicting a procedure of generating a prediction model.

FIG. 5 is a flowchart depicting a prediction procedure using the prediction model.

FIG. 6A is an explanatory diagram depicting performance evaluation of the prediction model.

FIG. 6B is an explanatory diagram depicting performance evaluation of the prediction model.

FIG. 6C is an explanatory diagram depicting performance evaluation of the prediction model.

FIG. 7A is a graph depicting a spatial distribution of a degree of importance for each observed data item.

FIG. 7B is a graph depicting a spatial distribution of a degree of importance for each observed data item.

FIG. 7C is a graph depicting a spatial distribution of a degree of importance for each observed data item.

FIG. 8 is a flowchart depicting a procedure of a process executed by an information processing apparatus according to Embodiment 2.

FIG. 9 is an explanatory diagram depicting a prediction method in Embodiment 3.

FIG. 10 is a flowchart depicting a procedure of a process executed by an information processing apparatus according to Embodiment 4.

FIG. 11 is a flowchart depicting a procedure of a process executed by an information processing apparatus according to Embodiment 5.

### DETAILED DESCRIPTION

Hereinafter, an embodiment will be described with reference to the drawings. In the description, the same elements or elements having the same functions are denoted by the same reference numerals, and a duplicated description thereof will be omitted.

### Embodiment 1

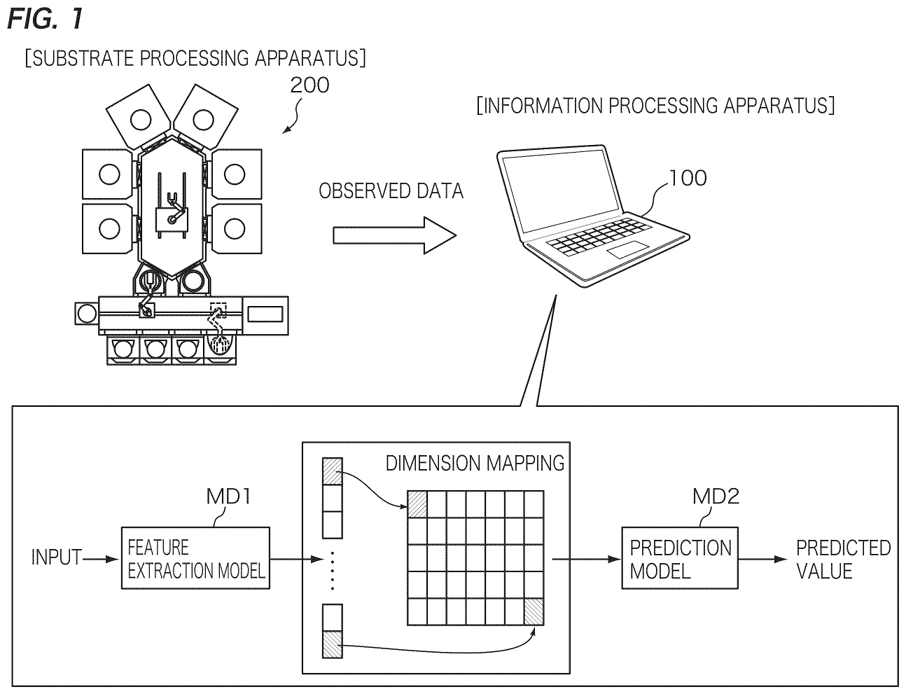

FIG. 1 is an explanatory diagram depicting a configuration of an information processing system according to an embodiment. The information processing system according to the embodiment includes an information processing apparatus 100 and a substrate processing apparatus 200 that are connected such that they can communicate with each other.

The substrate processing apparatus 200 is, for example, a semiconductor manufacturing apparatus including at least one of an exposure device, an etching device, a film forming device, an ion implantation device, an ashing device, a sputtering device, and the like. Alternatively, the substrate processing apparatus 200 may be a display manufacturing apparatus that manufactures plat display panels (FDPs) such as liquid crystal display panels and organic electro-luminescence (EL) panels.

When a process is started in the substrate processing apparatus 200, various setting values, such as the temperature of a substrate, pressure and gas flow rate in a chamber, and a voltage applied by a high-frequency power source, are set. The setting values are given by, for example, a process recipe. In addition, the substrate processing apparatus 200 is provided with various sensors and devices for measuring the temperature of the substrate, the pressure and gas flow rate in the chamber, the voltage applied to an upper electrode and a lower electrode, plasma emission intensity, and the like, and various measurement values are measured while a process is being executed. Further, in the substrate processing apparatus 200, in addition to the above-mentioned measurement values, appropriate time-series data, such as the images (RGB data) of the substrate (wafer) before and after the process and process logs, are collected at any time. The substrate processing apparatus 200 outputs the measurement values, the images, the time-series data, and the like obtained during the execution of the process as observed data to the information processing apparatus 100.

The information processing apparatus 100 acquires the observed data as data related to substrate processing from the substrate processing apparatus 200. The information processing apparatus 100 computes predicted values related to the substrate processing based on the acquired observed data.

Virtual measurement using observed data is performed in the related art. For example, in the related art, some input signals, such as sensor measurement values, image data, and time-series data, are input to a machine learning model corresponding to the input signals, and the machine learning model executes computation to compute required predicted values.

However, the machine learning models according to the related art have problems with accuracy and interpretability because they are not designed to take spatial correlation into account. For example, when the spatial correlation is not taken into account, independent predictions are made for each site. Therefore, a large difference may occur between the predicted values even at adjacent sites. As a result, the prediction results are likely to be spatially distorted. In addition, when the spatial correlation is not taken into account, it is difficult to know which parameters are likely to be effective at which sites.

Therefore, in this embodiment, a model into which dimension mapping has been introduced is proposed as a prediction model MD2 that takes spatial correlation into account. The dimension mapping means converting the dimension of features (variables that serve as a clue for prediction) extracted from the observed data to be matched with a physical dimension (target dimension) for which a predicted value is desired to be computed. For example, a machine learning model (hereinafter, referred to as a feature extraction model MD1) is used to extract the features. In Embodiment 1, the dimension mapping is introduced into a unimodal network structure, and the spatial correlation is explicitly taken into account, which results in improvements in accuracy and interpretability.

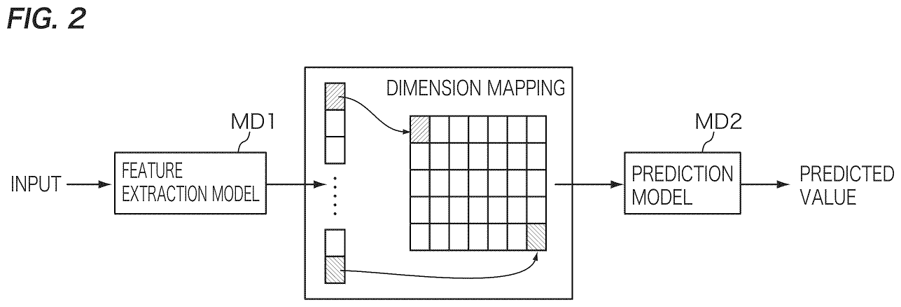

FIG. 2 is an explanatory diagram depicting a prediction method according to Embodiment 1. The information processing apparatus 100 acquires data related to the substrate processing from the substrate processing apparatus 200. The data acquired by the information processing apparatus 100 is any data and is observed data including measurement data output from the sensors and the like of the substrate processing apparatus 200, image data obtained by capturing the image of the substrate to be processed, time-series data, such as process logs, and the like.

The information processing apparatus 100 extracts the features of the observed data acquired from the substrate processing apparatus 200, using the feature extraction model MD1 (first learning model) trained such that it receives observed data as an input and outputs features of the observed data. It is preferable that the features to be extracted are variables that serve a clue for prediction.

A machine learning model including deep learning can be used as the feature extraction model MD1. For example, a learning model based on Convolutional Neural Network (CNN), Transformer, Recurrent Neural Networks (RNN), Long Short Term Memory (LSTM), Multi-Layer Perceptrons (MLP), and the like can be used. Alternatively, learning models, such as an autoregressive model, a moving average model, and an autoregressive moving average model, other than deep learning may be used. The learning model used as the feature extraction model MD1 is appropriately set according to the input observed data or the features to be extracted.

The feature extraction model MD1 includes, for example, an input layer, one or more intermediate layers, and an output layer and is trained so as to output features from the output layer in response to the input of the observed data to the input layer. Alternatively, a value that is output from any one of the intermediate layers may be used as the feature. The feature extraction model MD1 may be configured to have only the input layer and the output layer, without including the intermediate layer. In this embodiment, the dimension of the features output from the feature extraction model MD1 is described as one dimension. However, the dimension of the features may be two or more dimensions.

Then, the information processing apparatus 100 converts (dimension mapping) the dimension of the extracted features to be matched with the target dimension (the physical dimension to be computed as the predicted value). When it is desired to compute an etching rate, an etching shape (an opening width or an opening depth), a film thickness, and the like at each site on the surface of the substrate as the predicted values, the dimension of the extracted features may be converted into two dimensions. In the example depicted in FIG. 2, dimension mapping from one-dimensional features to two-dimensional features is depicted. The dimensions before and after the conversion may be any dimensions and are set appropriately depending on the observed data used and the predicted values desired to be computed. In some cases, the target dimension is expanded or contracted or is equal to the dimension of the features before the conversion. When the features output from the feature extraction model MD1 are one-dimensional features consisting of N elements (N=Nₓ×N_{y}), each element can be rearranged (mapped) into an Nₓ×N_{y} matrix to convert the one-dimensional features into two-dimensional features.

The information processing apparatus 100 computes the predicted values related to the substrate processing, using the prediction model MD2 (second learning model) trained to receive the features subjected to the dimension mapping as an input and to output the predicted values related to the substrate processing.

A machine learning model including deep learning can be used as the prediction model MD2. For example, learning models based on CNN, Transformer, RNN, LSTM, MLP, and the like can be used. Alternatively, learning models, such as an autoregressive model, a moving average model, and an autoregressive moving average model, other than deep learning may be used. The learning model used as the prediction model MD2 is appropriately set according to the target dimension of the input features or the predicted values to be computed.

In this embodiment, for convenience of explanation, the dimension mapping has been described as an independent process. However, the dimension mapping may be a process executed inside the prediction model MD2. Therefore, the prediction model MD2 is also called a dimension mapping model.

Further, in this embodiment, for convenience, the feature extraction model MD1 and the prediction model MD2 have been described as independent learning models. However, the models may be constructed as one learning model. In this case, the extraction of the features, the dimension mapping, and the computation of the predicted values are executed in the one learning model.

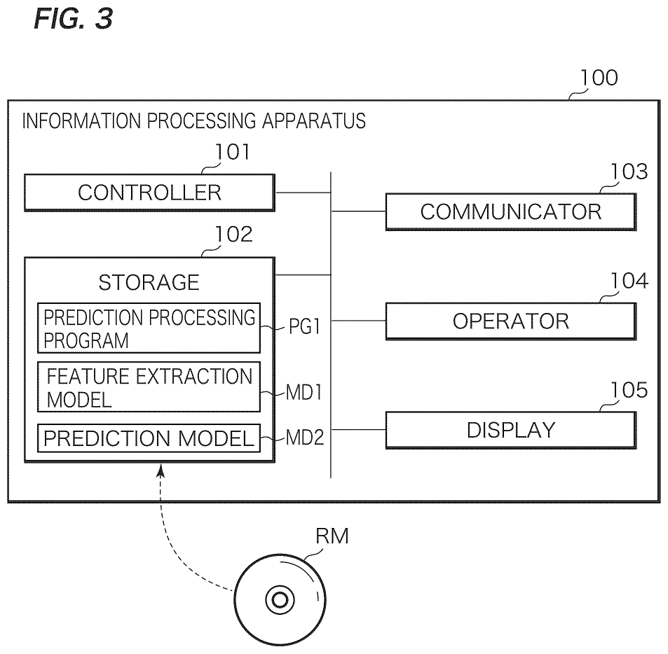

FIG. 3 is a block diagram depicting an internal configuration of the information processing apparatus 100. The information processing apparatus 100 is, for example, a dedicated or general-purpose computer including a controller 101, a storage 102, a communicator 103, an operator 104, and a display 105.

The controller 101 includes a central processing unit (CPU), a read only memory (ROM), a random access memory (RAM), and the like. The ROM included in the controller 101 stores, for example, a control program for controlling the operation of each hardware unit included in the information processing apparatus 100. The CPU in the controller 101 reads the control program stored in the ROM or a computer program (which will be described below) stored in the memory unit 102 and executes the program to control the operation of each hardware unit such that the entire apparatus functions as the information processing apparatus according to the present disclosure. The RAM included in the controller 101 temporarily stores data used during the execution of computations.

In the embodiment, the controller 101 is configured to include the CPU, the ROM, and the RAM. However, the configuration of the controller 101 is not limited to the above. The controller 101 may be, for example, one or more control circuits, arithmetic circuits or circuitry including a graphics processing unit (GPU), a field programmable gate array (FPGA), a digital signal processor (DSP), a quantum processor, a volatile or non-volatile memory, and the like. In addition, the controller 101 may also have functions of a clock that outputs date and time information, a timer that measures the elapsed time from when a measurement start instruction is given to when a measurement end instruction is given, a counter that counts numbers, and the like.

The storage 102 includes a storage device such as a hard disk drive (HDD), a solid state drive (SSD), or an electronically erasable programmable read only memory (EEPROM). The storage 102 stores various computer programs executed by the controller 101 and various types of data used by the controller 101.

The computer programs (program products) stored in the storage 102 include a prediction processing program PG1 for causing the computer to execute a process of computing the predicted values related to the substrate processing from the observed data of the substrate processing apparatus 200. The prediction processing program PG1 may be a single computer program or may be a program group composed of a plurality of computer programs. The prediction processing program PG1 may be executed by a plurality of computers in cooperation with each other. In addition, the prediction processing program PG1 may partially use the existing library.

The computer programs including the prediction processing program PG1 are provided by a non-transitory recording medium RM on which the computer programs have been recorded in a readable format. The recording medium RM is a portable memory such as a CD-ROM, a USB memory, a secure digital (SD) card, a micro SD card, or CompactFlash (registered trademark).

The controller 101 reads various computer programs from the recording medium RM using a reading device (not depicted) and stores the read various computer programs in the storage 102. In addition, the computer programs stored in the storage 102 may be provided by communication. In this case, the controller 101 acquires the computer programs by communication via the communicator 103 and stores the acquired computer programs in the storage 102.

Further, the storage 102 also stores the feature extraction model MID used in the process of extracting the features from the observed data and the prediction model MD2 used in the process of computing the predicted values related to the substrate processing from the features after the conversion into the target dimension. Alternatively, the feature extraction model MID and the prediction model MD2 may be stored in an external apparatus. In this case, the controller 101 of the information processing apparatus 100 may access the external apparatus via a communication network, transmit the observed data acquired from the substrate processing apparatus 200 to the external apparatus, and acquire the predicted values obtained as the computation results by the external apparatus via the communication network.

The communicator 103 includes a communication interface for transmitting and receiving various types of data to and from the external apparatus. A communication interface conforming to a communication standard, such as a local area network (LAN), can be used as the communication interface of the communicator 103. The external apparatus is the substrate processing apparatus 200, a user terminal (not depicted), or the like. When data to be transmitted is input from the controller 101, the communicator 103 transmits the data to the destination external apparatus. When the data transmitted from the external apparatus is received, the communicator 103 outputs the received data to the controller 101.

The operator 104 includes operation devices, such as a touch panel, a keyboard, and switches, and receives various operations and settings from the user or the like. The controller 101 performs appropriate control based on various types of operation information given by the operator 104 and stores setting information in the storage 102 as necessary.

The display 105 includes a display device, such as a liquid crystal monitor or an organic electro-luminescence (EL) monitor, and displays information to be notified to the user or the like in response to an instruction from the controller 101.

The information processing apparatus 100 according to this embodiment may be a single computer or may be a computer system configured by a plurality of computers, peripheral devices, and the like. In addition, the information processing apparatus 100 may be a virtual machine whose substance has been virtualized or may be a cloud. Further, in this embodiment, the information processing apparatus 100 and the substrate processing apparatus 200 have been described as separate apparatuses. However, the information processing apparatus 100 may be provided in the substrate processing apparatus 200.

The operation of the information processing apparatus 100 will be described below.

The information processing apparatus 100 according to this embodiment generates the prediction model MD2 in a learning phase before the actual operation of the substrate processing apparatus 200 is started.

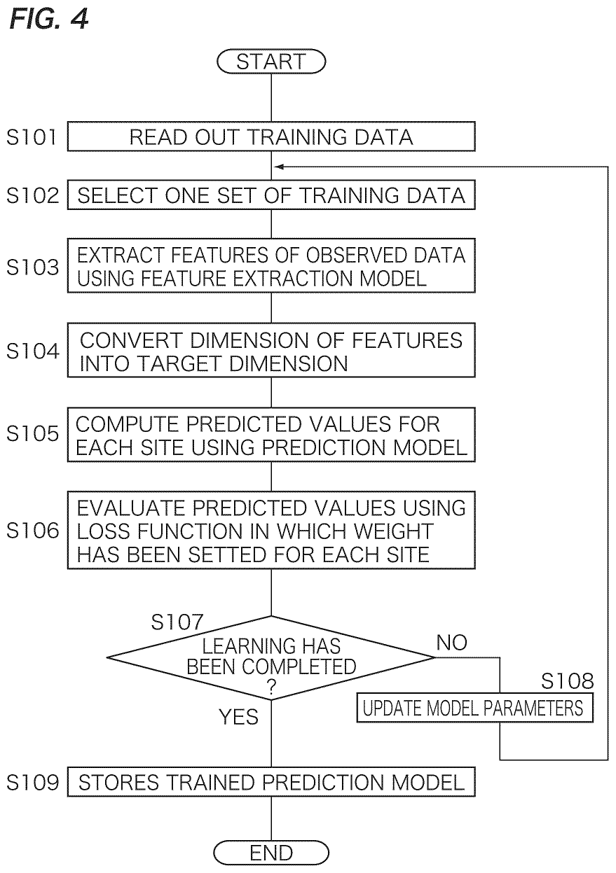

FIG. 4 is a flowchart depicting a procedure of generating the prediction model MD2. Before the prediction model MD2 is generated, training data required for learning is collected. For example, when the etching shape at each site on the surface of the substrate is computed as the predicted value based on the plasma emission intensity, measurement data of the plasma emission intensity measured by an optical emission spectrometer (OES) and measurement data of the etching shape at each site measured using an optical observation device, an ultrasonic microscope, or the like are collected as the training data. The training data is not limited to the measurement data of the plasma emission intensity and the etching shape, and observed data of the values used for prediction and the actually measured values of the values desired to be predicted are collected as the training data. The collected training data is stored in the storage 102 of the information processing apparatus 100. It is assumed that the feature extraction model MD1 has been generated in advance using a known algorithm.

The controller 101 reads out the training data stored in the storage 102 (Step S101) and selects one set of training data from the read-out training data (Step S102). The controller 101 inputs the observed data (values used for prediction) included in the selected training data to the feature extraction model MD1 and executes computation using the feature extraction model MD1 to extract features of the observed data (Step S103).

The controller 101 converts the dimension of the features extracted from the observed data into the target dimension (Step S104). That is, the controller 101 performs dimension mapping on the dimension of the extracted features according to the physical dimension desired to be computed as the predicted value.

The controller 101 inputs the features converted into the target dimension to the prediction model MD2 and executes computation using the prediction model MD2 to compute the predicted values for each site (Step S105). It is assumed that initial values are set for the model parameters of the prediction model MD2 in a stage before learning is started. In addition, in this flowchart, the dimension mapping process and the computation process by the prediction model MD2 are described as independent processes. However, the dimension mapping may be executed in the process of the prediction model MD2.

The controller 101 evaluates the predicted values computed in Step S105 (Step S106) and determines whether or not learning has been completed (Step S107). A known loss function is used to evaluate the predicted values. When the value of the loss function is less than a threshold value in the process of optimizing (minimizing) the loss function, the controller 101 can determine that the learning of the prediction model MD2 has been completed.

When it is determined that the learning has not been completed (S107: NO), the controller 101 updates the model parameters (weighting coefficients and biases between nodes) of the prediction model MD2 (Step S108) and returns the process to Step S102.

When it is determined that the learning has been completed (S107: YES), the controller 101 stores the model as the trained prediction model MD2 in the storage 102 since a trained model is obtained (Step S109).

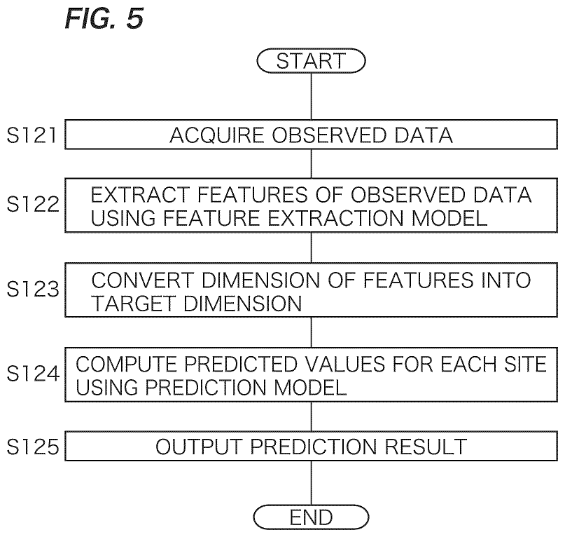

The information processing apparatus 100 performs prediction using the prediction model MD2 in an operation phase after the prediction model MD2 is generated. FIG. 5 is a flowchart depicting a prediction procedure using the prediction model MD2. The controller 101 of the information processing apparatus 100 acquires the observed data used for prediction from the substrate processing apparatus 200, for example, via the communicator 103 (Step S121).

The controller 101 inputs the acquired observed data to the feature extraction model MD1 and executes computation using the feature extraction model MD1 to extract features of the observed data (Step S122).

The controller 101 converts the dimension of the features extracted from the observed data into the target dimension (Step S123). That is, the controller 101 performs dimension mapping on the dimension of the extracted features according to the physical dimension desired to be computed as the predicted value.

The controller 101 inputs the features converted into the target dimension to the prediction model MD2 and executes computation using the prediction model MD2 to compute the predicted values for each site (Step S124).

The controller 101 outputs the prediction result by the prediction model MD2 (Step S125). The controller 101 may display the prediction result on the display 105 or may notify the user terminal or the like of the prediction result via the communicator 103.

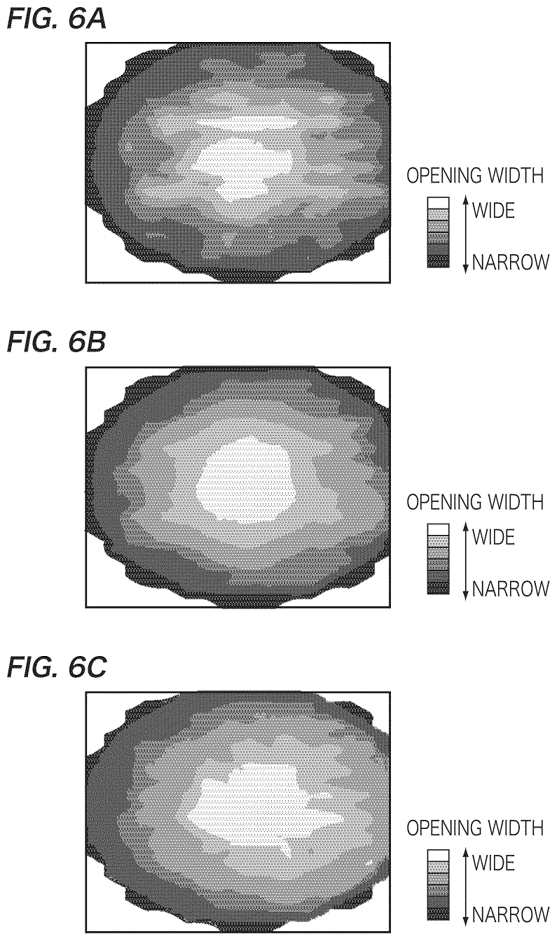

FIGS. 6A to 6C are an explanatory diagram depicting performance evaluation of the prediction model MD2. Each graph in FIGS. 6A to 6C depicts an in-plane distribution when the etching shape (opening width) is virtually or actually measured. In each graph, the horizontal axis corresponds to a first direction in the plane of the substrate, and the vertical axis corresponds to a second direction of the substrate perpendicular to the first direction. The shading depicted in each graph corresponds to the opening width. The lighter areas indicate wider opening width, and darker areas indicate narrower opening widths. FIG. 6A depicts the prediction results (virtual measurement) by the method according to the related art, FIG. 6B depicts the prediction results (virtual measurement) by the method according to the present disclosure, and FIG. 6C depicts the actually measured values by actual measurement.

In the actual measurement, a large number of openings were formed in the surface of the substrate by etching, and the width of each opening was measured using a measurement device such as an optical observation device or an ultrasonic microscope. In the virtual measurement, the image of the surface of the substrate, in which the same openings were formed, was captured by a camera, and the opening width was predicted using the obtained captured image as the observed data. An RGB three-color image captured by a wafer optical inspection system was used as the captured image.

The design value of the opening width was constant regardless of the site where the opening was formed. However, when the width of the opening formed in the substrate was actually measured, an in-plane distribution was confirmed in which the opening width was the widest near the center of the surface of the substrate and decreased toward the periphery, as depicted in FIG. 6C.

On the other hand, when the opening width was predicted using the method according to the related art (linear regression in this example), as depicted in FIG. 6A, the opening width was the widest near the center of the surface of the substrate and tended to gradually decrease toward the periphery. However, a region in which the opening width was the same spread in the horizontal direction of the graph, and the prediction results were distorted.

In contrast, when the opening width was predicted using the method according to the present disclosure (prediction model MD2), as depicted in FIG. 6B, the prediction results were not distorted in a specific direction, and a uniform distribution was obtained in a circumferential direction close to the actual measurement. While the mean square error between the predicted value and the actually measured value by the method according to the related art was about 0.8, the mean square error between the predicted value and the actually measured value by the method according to the present disclosure was about 0.6, indicating a significant improvement in prediction accuracy.

FIGS. 6A to 6C depict the prediction results using the captured image as the observed data. However, when the opening width was predicted using the plasma emission intensity or the process logs as the observed data, the prediction results depicted that, in the method according to the present disclosure, prediction accuracy was more improved than that in the method according to the related art.

As described above, Embodiment 1 discloses the method that introduces spatial correlation into the machine learning model using dimension mapping and performs virtual measurement using the learning model (prediction model MD2). The use of the spatial correlation makes the model easier to interpret and makes it possible to reflect the actual spatial distribution in the prediction. In addition, it was found that prediction accuracy was significantly improved as compared to the method according to the related art that did not take spatial correlation into account.

### Embodiment 2

In Embodiment 2, a configuration will be described that computes a degree of importance (also called a degree of contribution) of features for each site and outputs a spatial distribution of the computed degree of importance.

An information processing apparatus 100 according to Embodiment 2 computes the degree of importance (degree of contribution) of the features for each site, using the prediction model MD2. A known method, such as Local Interpretable Model-Agnostic Explanations (Lime), SHapley Additive exPlanations (SHAP), or Class Activation Mapping (CAM), is used to compute the degree of importance. Lime and SHAP are methods that specify how much the output changes when the input is reduced and determine that, as a change in the output is larger, the degree of importance is higher. CAM is a method that computes the degree of importance using error backpropagation during learning.

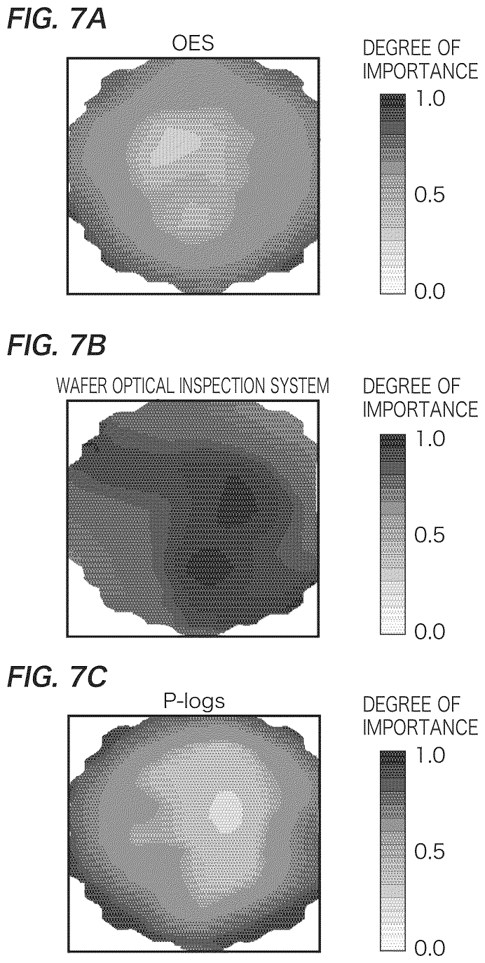

FIGS. 7A to 7C are a graph depicting the spatial distribution of the degree of importance for each observed data item. FIG. 7A depicts the spatial distribution of the degree of importance when plasma emission intensity (OES) is used as the observed data, FIG. 7B depicts the spatial distribution of the degree of importance when the captured image (wafer optical inspection system) is used as the observed data, and FIG. 7C depicts the spatial distribution of the degree of importance when the process logs (P-logs) are used as the observed data. In each graph, the horizontal axis corresponds to the first direction in the plane of the substrate, and the vertical axis corresponds to the second direction of the substrate perpendicular to the first direction. The shading depicted in each graph corresponds to the level of importance. The darker areas on the graph indicates a site with a high degree of importance, and the lighter areas indicates a site with a low degree of importance.

When the opening width was predicted using the plasma emission intensity as the observed data, the spatial distribution was obtained in which the degree of importance of the features based on the plasma emission intensity decreased toward the center of the substrate and increased toward the periphery of the substrate (FIG. 7A). As can be seen from this graph, when the plasma emission intensity is used as the observed data, the opening width at the periphery of the substrate can be predicted with high accuracy. The same results were obtained when the process logs were used as the observed data (FIG. 7C).

On the other hand, when the opening width was predicted using the image captured by the wafer optical inspection system as the observed data, the spatial distribution was obtained in which the degree of importance of the features based on the captured image was low in some regions (regions corresponding to the upper right and lower left corners of the graph) in the periphery of the substrate and was high in the other regions (FIG. 7B). As can be seen from this graph, when the captured image is used, the opening width can be predicted with high accuracy in the regions excluding a portion of the periphery of the substrate.

As described above, the spatial distribution of the degree of importance differs depending on the type (feature) of observed data. Therefore, when the prediction model MD2 is generated, learning may be performed using a loss function in which a weight has been adjusted for each site. For example, when the plasma emission intensity or the process logs are used as the observed data, learning may be performed, using a loss function in which a weight for a peripheral portion has been increased, to generate the prediction model MD2 specialized for the peripheral portion. In addition, when the image captured by the wafer optical inspection system is used as the observed data, learning may be performed, using a loss function in which a weight for a central portion has been increased, to generate the prediction model MD2 specialized for the central portion.

Further, in this embodiment, it is possible to check the degree of contribution of the features for each site. Therefore, for example, it is possible to know to which portion of the substrate the output value of the sensor present in the process logs contributes, and the process can be adjusted such that the output value of the sensor changes, which leads to improvement in the process. In addition, in the actual substrate processing, a process state in the peripheral portion is not good. Therefore, when there are circumstances such as poor yield, the prediction model MD2 specialized for the peripheral portion may be created using the above-mentioned method, and the process may be improved in consideration of the prediction results of the prediction model MD2.

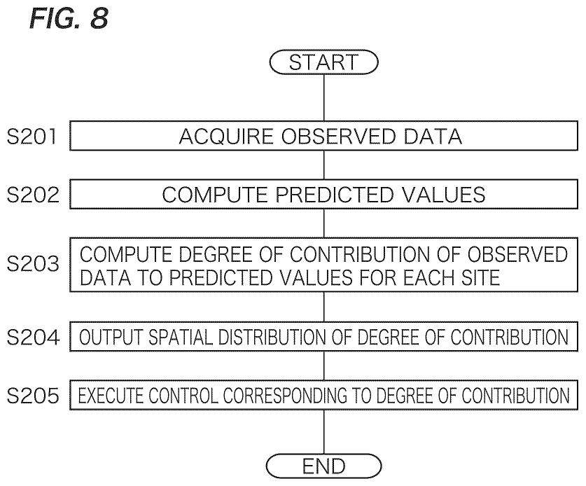

FIG. 8 is a flowchart depicting a procedure of a process executed by the information processing apparatus 100 according to Embodiment 2. The controller 101 of the information processing apparatus 100 acquires the observed data used for prediction from the substrate processing apparatus 200 via, for example, the communicator 103 (Step S201).

The controller 101 computes the predicted values for each site based on the acquired observed data (Step S202). A method for computing the predicted values is the same as in Embodiment 1. That is, the controller 101 inputs the acquired observed data to the feature extraction model MD1 to extract features and maps the dimension of the extracted features to the target dimension (a physical dimension desired to be computed as the predicted value). Then, the controller 101 inputs the features subjected to the dimension mapping to the prediction model MD2 and performs computation to compute the predicted values for each site.

The controller 101 computes the degree of contribution of the observed data to the computed predicted values for each site (Step S203). The degree of contribution is, for example, a SHAP value that can be computed using the prediction model MD2. The SHAP value is a value corresponding to a difference between a predicted value computed by inputting a plurality of observed data items to the prediction model MD2 and a predicted value computed by the prediction model MD2 when one of the plurality of observed data items is not present. The degree of contribution is not limited to the SHAP value, but can be computed using the existing methods such as Lime and CAM.

The controller 101 outputs the spatial distribution of the degree of contribution (Step S204). The controller 101 creates graphs (color contour maps), such as the graphs depicted in FIGS. 7A to 7C, based on the degree of contribution for each site computed in Step S203 and displays the graphs on the display 105. In addition, the controller 101 may transmit the created graphs to the user terminal.

The controller 101 executes control corresponding to the degree of contribution for each site (Step S205). The controller 101 adjusts parameters for a control target according to the degree of contribution for each site and controls the process according to the adjusted parameters. For example, when it is found that the plasma emission intensity at a particular frequency contributes well to the vicinity of the peripheral portion, process control can be performed that adjusts the gas flow rate such that the emission intensity increases, thereby improving in-plane uniformity. The amount of adjustment of the parameters for the degree of contribution is determined, for example, on a rule basis.

Furthermore, in the procedures of the flowchart depicted in FIG. 8, after the spatial distribution of the degree of contribution is output in Step S204, control corresponding to the degree of contribution is executed in Step S205. However, these procedures may be performed in any order, or only one of the procedures may be executed.

As described above, in Embodiment 2, the degree of importance (degree of contribution) of the features is computed for each site, and the spatial distribution of the computed degree of importance is output. Therefore, it is possible to understand which parameters are effective in which sites, which leads to process improvement and control.

### Embodiment 3

In Embodiment 3, a configuration will be described in which the predicted values are computed from a plurality of types of observed data.

In general, there are several measurement points on a single wafer. These measurement points are not independently computed, but features are extracted or the predicted values are computed based on the physical dimension of the measurement points, which makes it possible to create a model with high accuracy and interpretability.

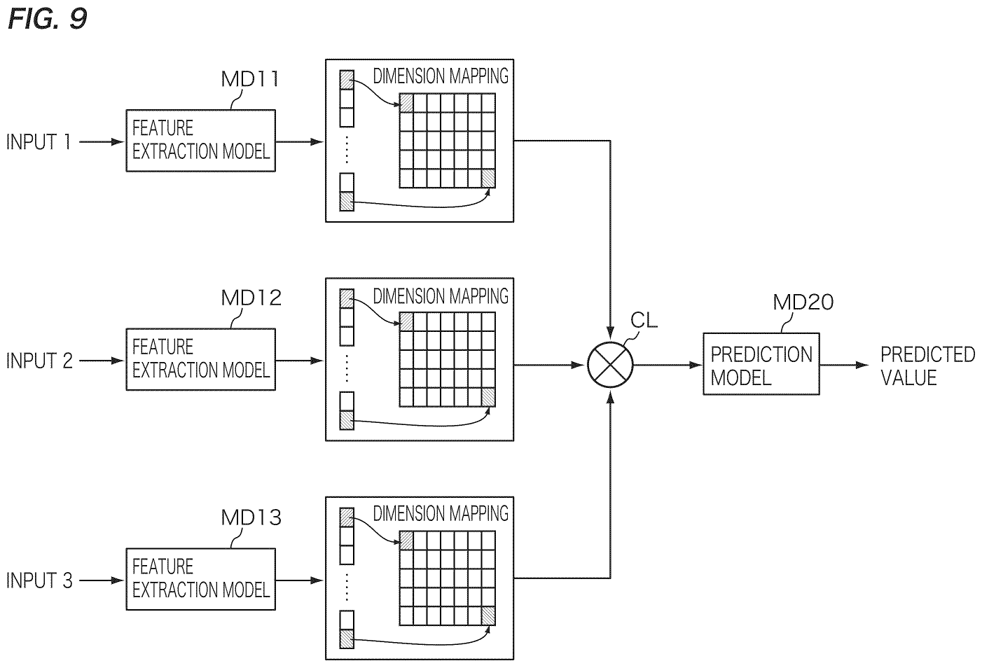

FIG. 9 is an explanatory diagram depicting a prediction method according to Embodiment 3. In Embodiment 3, multimodal virtual measurement that takes spatial correlation into account will be described. The information processing apparatus 100 acquires a plurality of types of observed data. In FIG. 9, inputs 1 to 3 are observed data to be input to feature extraction models MD 11, MD12, and MD13, respectively. For example, input 1 is the plasma emission intensity by the OES, input 2 is the image captured by the wafer optical inspection system, and input 3 is the process logs. The observed data used for prediction is not limited to three types, but may be two types or four or more types.

The feature extraction model MD 11 is a model corresponding to the feature extraction model MD1 described in Embodiment 1 and is trained to output the features of the observed data when the observed data of input 1 is input. The same applies to the feature extraction models MD12 and MD13. The feature extraction models MD12 and MD13 are trained to output the features of inputs 2 and 3 when the observed data of inputs 2 and 3 is input, respectively. The trained feature extraction models MID 1, MD12, and MD13 are stored in the storage 102 of the information processing apparatus 100.

The information processing apparatus 100 extracts the features of inputs 1 to 3, using the feature extraction models MID 1 to MD13, respectively, and converts the dimension of each of the extracted features into the target dimension. The dimension mapping described in Embodiment 1 is used to convert the dimension of the features. When the features extracted from the feature extraction model MD 11 are converted into, for example, Nₓ×N_{y} two-dimensional features, the features extracted from the feature extraction models MD12 and MD13 are also converted into Nₓ×N_{y} two-dimensional features.

The information processing apparatus 100 concatenates the features subjected to the dimension conversion in a concatenation layer CL. When the Nₓ×N_{y} two-dimensional features are obtained for each feature, a channel may be added, and the features may be concatenated in a channel direction as Nₓ×N_{y}×C. Here, C is the number of inputs (the number of types of observed data). In the case of FIG. 9, C is 3.

The information processing apparatus 100 inputs the features concatenated in the concatenation layer CL to a prediction model MD20 to compute predicted values. The prediction model MD20 is a model corresponding to the prediction model MD2 described in Embodiment 1 and is trained to output predicted values related to the substrate processing in response to the input of the features. The type of model that can be used as the prediction model MD20, a model learning method, and the like are the same as in Embodiment 1. The trained prediction model MD20 is stored in the storage 102 of the information processing apparatus 100. The information processing apparatus 100 computes the predicted values at each site of the substrate, using the prediction model MD20 stored in the storage 102.

As described above, Embodiment 3 discloses the method that performs multimodal virtual measurement using the learning model (prediction model MD20) into which spatial correlation has been introduced. Since the method disclosed in Embodiment 2 is applied to the prediction model MD20, it is possible to compute the degree of contribution of the features for each modality and each site. This makes it possible to understand the site specialized for each modality in the dimension, and interpretability is improved.

In addition, it is possible to explicitly use the site specialized for each modality in the dimension. For example, prediction accuracy can be improved by predicting the peripheral portion of the substrate using the plasma emission intensity by the OES and the process logs and predicting the region excluding the peripheral portion of the substrate using the image captured by the wafer optical inspection system. Furthermore, it is possible to analyze which modality affects which site, leading to improvements in modalities and processes.

### Embodiment 4

In Embodiment 4, a configuration will be described in which an alert is output according to the predicted value.

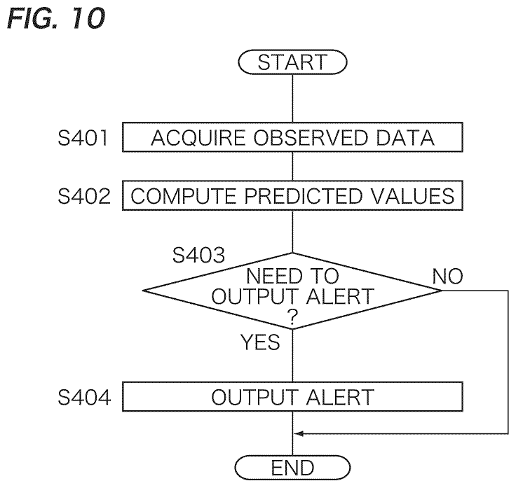

FIG. 10 is a flowchart depicting a procedure of a process executed by the information processing apparatus 100 according to Embodiment 4. The controller 101 of the information processing apparatus 100 acquires observed data used for prediction from the substrate processing apparatus 200, for example, via the communicator 103 (Step S401).

The controller 101 computes the predicted values for each site based on the acquired observed data (Step S402). A method for computing the predicted values is the same as in Embodiment 1. That is, the controller 101 inputs the acquired observed data to the feature extraction model MD1 to extract features and maps the dimension of the extracted features to the target dimension. Then, the controller 101 inputs the features subjected to the dimension mapping to the prediction model MD2 and performs computation to compute the predicted values for each site. When a plurality of types of observed data are obtained as the observed data used for prediction, the controller 101 may compute the predicted values with the prediction model MD20, using the method disclosed in Embodiment 3.

The controller 101 determines whether or not an alert needs to be output based on the computed predicted value (Step S403). For example, the controller 101 compares the computed predicted value with a preset threshold value and determines that the alert needs to be output when the predicted value is greater than the threshold value (or is less than the threshold value). Alternatively, the controller 101 may determine whether or not the predicted value is within a present normal range and determine that the alert needs to be output when the predicted value is outside the normal range. In addition, the threshold value and the normal range may be set for each site to be predicted.

When it is determined that the alert does not need to be output (S403: NO), the controller 101 ends the process of this flowchart without outputting the alert.

When it is determined that the alert needs to be output (S403: YES), the controller 101 outputs the alert (Step S404). For example, the controller 101 displays, on the display 105, information indicating that the substrate processing is not normal to output the alert. Alternatively, the controller 101 may notify the user terminal or the like of the information indicating that the substrate processing is not normal via the communicator 103.

In this embodiment, prediction is performed using the prediction model (prediction model MD2 or MD20) that takes spatial correlation into account. Therefore, it is possible to obtain more accurate predicted values. In this embodiment, since the highly accurate predicted value is compared with the threshold value or the normal range, it is possible to more accurately determine whether or not the alert needs to be output.

### Embodiment 5

In Embodiment 5, a configuration will be described in which control in substrate processing is performed based on the predicted values.

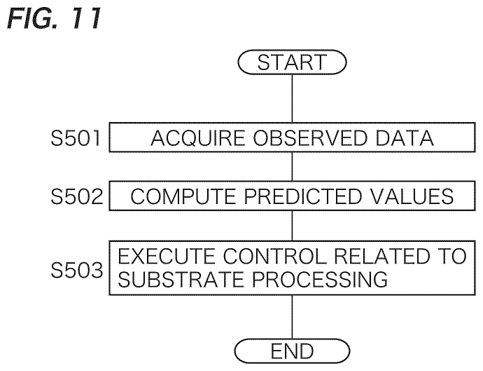

FIG. 11 is a flowchart depicting a procedure of a process executed by the information processing apparatus 100 according to Embodiment 5. The controller 101 of the information processing apparatus 100 acquires the observed data used for prediction from the substrate processing apparatus 200 via, for example, the communicator 103 (Step S501).

The controller 101 computes the predicted values for each site based on the acquired observed data (Step S502). A method for computing the predicted values is the same as in Embodiment 1. That is, the controller 101 inputs the acquired observed data to the feature extraction model MD1 to extract features and maps the dimension of the extracted features to the target dimension. Then, the controller 101 inputs the features subjected to the dimension mapping to the prediction model MD2 and computes the predicted values for each site. When a plurality of types of observed data are obtained as the observed data used for prediction, the controller 101 may compute the predicted values with the prediction model MD20, using the method disclosed in Embodiment 3.

The controller 101 executes control related to the substrate processing in the substrate processing apparatus 200 based on the computed predicted values (Step S503). For example, the controller 101 compares the computed predicted value with a preset reference value and computes a control value for the substrate processing apparatus 200 (for example, a control value that makes the predicted value approach the reference value) based on the deviation between the predicted value and the reference value. The reference value may be set for each site to be predicted. The controller 101 outputs a control command including the computed control value to the substrate processing apparatus 200, thereby performing the control related to the substrate processing.

In this embodiment, prediction is performed using the prediction models (prediction models MD2 and MD20) that take spatial correlation into account. Therefore, it is possible to obtain more accurate predicted values. In this embodiment, since the control related to the substrate processing is performed based on the highly accurate predicted value, the process can be improved.

The presently disclosed embodiments should be considered in all respects as illustrative and not restrictive. The scope of the present invention is not indicated by the above meaning, but is indicated by the claims, and is intended to include all modifications within the meaning and scope of the claims and equivalents.

The matters described in each embodiment can be combined with each other. In addition, the independent and dependent claims described in the claims can be combined with each other in all possible combinations, regardless of the citation format.

1. A non-transitory computer readable recording medium storing a computer program causing a computer to execute a process of:
acquiring data related to substrate processing;
extracting features of acquired data, using a first learning model which has been trained to output features of data in response to an input of the data;
converting extracted features into features having a target dimension set according to a physical feature to be predicted concerning the substrate processing; and
computing a predicted value by inputting the features with converted dimension to a second learning model, which has been trained to output the predicted value related to the physical feature in response to an input of the features having the target dimension.

2. The non-transitory computer readable recording medium according to claim 1, storing the computer program causing the computer to execute the process of:
setting the target dimension by expanding or contracting a dimension of the extracted feature in response to a dimension of the physical feature.

3. The non-transitory computer readable recording medium according to claim 1, storing the computer program causing the computer to execute the process of:
outputting data indicating a spatial distribution of the features with converted dimension.

4. The non-transitory computer readable recording medium according to claim 1, wherein the second learning model is trained using a loss function in which a weight is set for a spatial distribution of the features.

5. The non-transitory computer readable recording medium according to claim 1, storing the computer program causing the computer to execute the process of:
acquiring a plurality of types of data related to the substrate processing;
extracting features for each of acquired plurality of types of data using the first learning model;
converting each of the features extracted from each of the plurality of types of data into features having the target dimension; and
computing the predicted value by inputting each of the features with converted dimension to the second learning model.

6. The non-transitory computer readable recording medium according to claim 1, storing the computer program causing the computer to execute the process of:
computing a degree of contribution of the features for each of sites on a substrate to the predicted value; and
outputting computed results.

7. The non-transitory computer readable recording medium according to claim 1, storing the computer program causing the computer to execute the process of:
computing a degree of contribution of the acquired data to each of sites on a substrate; and
executing control in the substrate processing according to computed results.

8. The non-transitory computer readable recording medium according to claim 1, storing the computer program causing the computer to execute the process of:
outputting an alert according to the predicted value obtained using the second learning model.

9. The non-transitory computer readable recording medium according to claim 1, storing the computer program causing the computer to execute the process of:
executing control in the substrate processing based on the predicted value obtained using the second learning model.

10. The non-transitory computer readable recording medium according to claim 3, wherein the second learning model is trained using a loss function in which a weight is set for a spatial distribution of the features.

11. The non-transitory computer readable recording medium according to claim 10, storing the computer program causing the computer to execute the process of:
acquiring a plurality of types of data related to the substrate processing;
extracting features for each of acquired plurality of types of data using the first learning model;
converting each of the features extracted from each of the plurality of types of data into features having the target dimension; and
computing the predicted value by inputting each of the features with converted dimension to the second learning model.

12. The non-transitory computer readable recording medium according to claim 11, storing the computer program causing the computer to execute the process of:
computing a degree of contribution of the features for each of sites on a substrate to the predicted value; and
outputting computed results.

13. The non-transitory computer readable recording medium according to claim 12, storing the computer program causing the computer to execute the process of:
computing a degree of contribution of the acquired data to each of sites on a substrate; and
executing control in the substrate processing according to computed results.

14. The non-transitory computer readable recording medium according to claim 13, storing the computer program causing the computer to execute the process of:
outputting an alert according to the predicted value obtained using the second learning model.

15. The non-transitory computer readable recording medium according to claim 14, storing the computer program causing the computer to execute the process of:
executing control in the substrate processing based on the predicted value obtained using the second learning model.

16. A non-transitory computer readable recording medium storing a computer program causing a computer to execute a process of:
acquiring data related to substrate processing;
extracting features of acquired data, using a first learning model which has been trained to output the features of data in response to an input of the data;
converting extracted features into features having a target dimension set according to a physical feature to be predicted concerning the substrate processing;
setting a weight in a loss function for a spatial distribution of the features with converted dimension; and
generating a second learning model outputting a predicted value related to the physical feature in response to an input of the features, using the loss function in which the weight is set.

17. An information processing method by a computer comprising:
acquiring data related to substrate processing;
extracting features of acquired data, using a first learning model which has been trained to output the features of data in response to an input of the data;
converting extracted features into features having a target dimension set according to a physical feature to be predicted concerning the substrate processing; and
computing a predicted value by inputting the features with converted dimension to a second learning model, which has been trained to output the predicted value related to the physical feature in response to an input of the features having the target dimension.

18. An information processing apparatus comprising:
a processor; and
a storage storing instructions causing the processor to execute processing of:
acquiring data related to substrate processing;
extracting features of acquired data, using a first learning model which has been trained to output features of data in response to an input of the data;
converting extracted features into features having a target dimension set according to a physical feature to be predicted concerning the substrate processing; and
computing a predicted value by inputting the features with converted dimension to a second learning model, which has been trained to output the predicted value related to the physical feature in response to an input of the features having the target dimension.
